(19) United States
(12) Patent Application Publication
(10) Pub. No.: US 2026/0213567 A1
(43) Pub. Date: Jul. 23, 2026

(54) UNINTERRUPTIBLE POWER SYSTEM AND POWER SUPPLY CONTROL SYSTEM

(71) Applicant: KABUSHIKI KAISHA TOSHIBA, Kawasaki-shi (JP)

(72) Inventor: Tetsu SHIJO, Setagaya Tokyo (JP)

(73) Assignee: KABUSHIKI KAISHA TOSHIBA, Kawasaki-shi (JP)

(21) Appl. No.: 19/455,866

(22) Filed: Jan. 22, 2026

(30) Foreign Application Priority Data
Jan. 23, 2025 (JP) 2025-009849

(51) Int. Cl. H02J 9/06; H02J 7/82; H02J 7/90

(52) U.S. Cl. CPC H02J 9/062; H02J 7/82; H02J 7/933

(57) ABSTRACT

According to one embodiment, an uninterruptible power system is an uninterruptible power system that receives supply of electric power from a power grid to perform charging or supplies electric power to the power grid by performing discharging. The uninterruptible power system includes a secondary battery that is capable of charging and discharging. The uninterruptible power system also includes a frequency measurement device that measures frequencies at a plurality of time points in the power grid. The uninterruptible power system also includes a charge-discharge amount calculation device that determines a charge-discharge pattern indicating charging power or discharging power of the secondary battery based on an SoC of the secondary battery and the frequencies at the plurality of time points.

### CROSS REFERENCE TO RELATED APPLICATION

This application is based upon and claims the benefit of priority from the prior Japanese Patent Application No. 2025-009849, filed on Jan. 23, 2025, the entire contents of which are incorporated herein by reference.

### FIELD

Embodiments described herein relate to an uninterruptible power system and a power supply control system.

### BACKGROUND

An uninterruptible power system (also referred to as UPS) is a power supply that maintains supply of electric power to a load apparatus during a power outage by discharging from a secondary battery of the uninterruptible power system. The utilization of the uninterruptible power system as a resource of responsive reserve to a power grid in a frequency transient period for grid stabilization is being studied.

The UPS can quickly respond to a frequency variation, as compared to large-sized power generation facilities such as thermal power generation facilities and hydroelectric power generation facilities.

However, although the uninterruptible power system can quickly respond to a frequency variation as compared to power generation facilities, a load sharing is large in a frequency transient period, and the secondary battery is potentially over-discharged or fully charged at an early stage. On the other hand, the uninterruptible power system is desired to be utilized as a supply source that maintains supply of electric power to a load apparatus during a power outage.

### BRIEF DESCRIPTION OF THE DRAWINGS

FIG. 1 is a schematic configuration diagram of a power grid in a first embodiment;

FIG. 2 is a diagram for description of a frequency and charging characteristics;

FIG. 3 is an example of another configuration diagram of an uninterruptible power system in the first embodiment;

FIGS. 4 and 5 are diagrams for description of an example of a method of determining a discharge pattern in the first embodiment;

FIG. 6 is an example of a flowchart at a time of determining a charge-discharge pattern in the first embodiment;

FIG. 7 is an example of a flowchart at a time of determining a charge-discharge pattern and the like in a second embodiment;

FIG. 8 is a schematic configuration diagram of the power grid in a third embodiment;

FIG. 9 is a hardware configuration diagram of a power supply control system in the third embodiment; and

FIG. 10 is a schematic configuration diagram of the power grid in a fourth embodiment.

### DETAILED DESCRIPTION

### First Embodiment

Embodiments will now be explained with reference to the accompanying drawings. The present embodiments do not limit the present invention. The drawings are schematic or conceptual, and for example, the proportions of individual parts are not necessarily the same as those in reality. In the specification and the drawings, elements that are the same as those described with respect to previously-presented drawings are denoted by the same reference signs, and detailed description thereof is omitted as appropriate.

According to one embodiment, an uninterruptible power system is an uninterruptible power system that receives supply of electric power from a power grid to perform charging or supplies electric power to the power grid by performing discharging. In addition, the uninterruptible power system includes a secondary battery that is capable of charging and discharging. The uninterruptible power system also includes a frequency measurement device that measures frequencies at a plurality of time points in the power grid. The uninterruptible power system also includes a charge-discharge amount calculation device that determines a charge-discharge pattern indicating charging power or discharging power of the secondary battery based on an SoC of the secondary battery and the frequencies at the plurality of time points.

In the present disclosure, the terms “equal to or larger than” and “equal to or smaller than” can be appropriately interpreted as “larger than” and “smaller than”, respectively. In addition, the terms “larger than” and “smaller than” can be appropriately interpreted as “equal to or larger than” and “equal to or smaller than”, respectively.

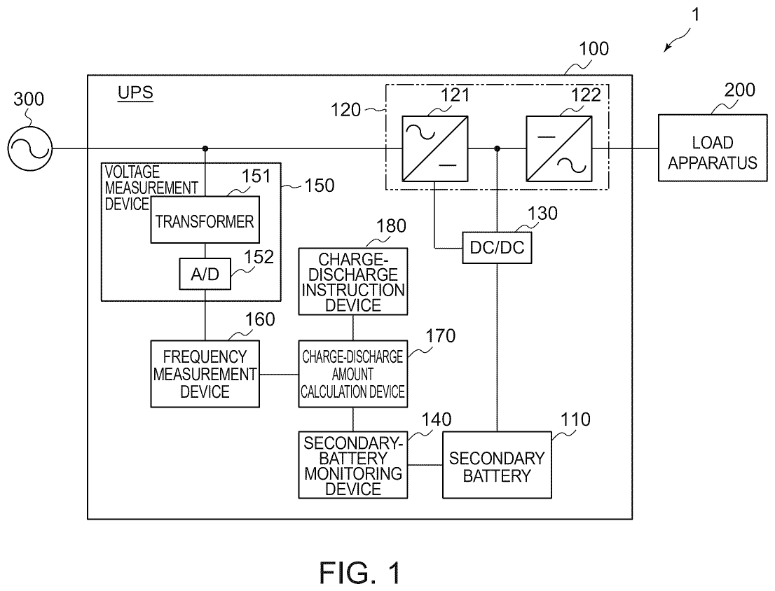

FIG. 1 is a schematic configuration diagram of a power grid 1 in a first embodiment.

The power grid 1 in the present embodiment includes an uninterruptible power system 100 and a load apparatus 200. The load apparatus 200 is connected to the uninterruptible power system 100 and is connected to a power grid 300 through the uninterruptible power system 100. For simplification of description, the power grid 1 in FIG. 1 has a configuration that includes one uninterruptible power system 100, but may have a configuration that includes a plurality of uninterruptible power systems 100 connected in parallel. Note that, in FIG. 1, illustration of any power reception equipment between the power grid 300 and the uninterruptible power system 100 is omitted.

The power grid 300 is, for example, a system for transmitting and supplying electric power generated by a power generation facility of a power generation operator to a power reception equipment of a consumer. In the following description of embodiments, a reference frequency in the power grid 300 is 50 Hz, but the reference frequency may be 60 Hz or another frequency. In addition, a power reception voltage in a consumer equipment may be 6.6 kV or various voltage classes. This voltage is transformed to a desired voltage value such as AC 400 V, AC 200 V, or AC 100 V by the power reception equipment, and is input to a UPS.

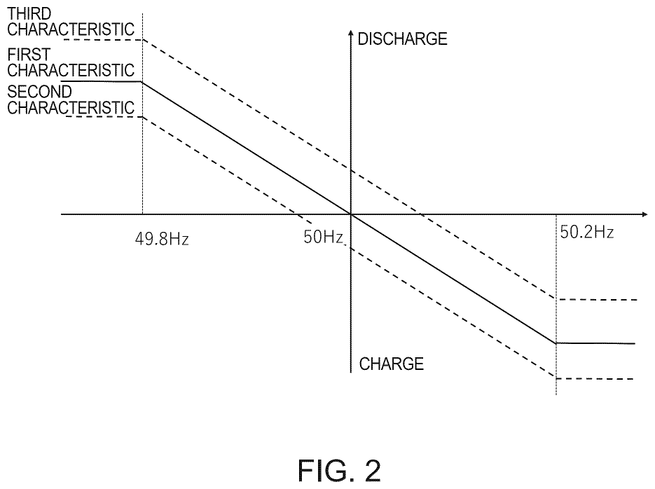

The uninterruptible power system 100 supplies responsive reserve by charging or discharging when a frequency variation occurs in the power grid 300. FIG. 2 illustrates frequency and charge-discharge characteristics. For example, in a first characteristic in FIG. 2, when the frequency of the power grid 300 is higher than the reference frequency due to a frequency variation, electric power is in excess in the power grid 300, and thus the uninterruptible power system 100 performs charging of a secondary battery 110. On the other hand, when the frequency of the power grid 300 is lower than the reference frequency due to a frequency variation, electric power is insufficient in the power grid 300, and thus the uninterruptible power system 100 performs discharging from the secondary battery 110. In the charge-discharge characteristics with respect to the frequency, a dead band in which a frequency variation is not performed may be provided in a frequency range between 49.99 Hz to 50.01 Hz, for example. In addition, as illustrated in FIG. 2, the charge-discharge characteristics may be constant at 49.8 Hz or lower and at 50.2 Hz or higher. In addition, as in a second characteristic and a third characteristic in FIG. 2, the charge-discharge characteristics with respect to the frequency may shift in a charging direction or in a discharging direction. A charging amount increases as the frequency becomes higher than the reference frequency, and a discharging amount increases as the frequency becomes lower than the reference frequency. A detailed configuration of the uninterruptible power system 100 will be described later.

The uninterruptible power system 100 includes the secondary battery 110, an adjustment device 120, a digital-to-digital (DC/DC) conversion device 130, a secondary-battery monitoring device 140, a voltage measurement device 150, a frequency measurement device 160, a charge-discharge amount calculation device 170, and a charge-discharge instruction device 180.

The secondary battery 110 is a battery that is capable of charging and discharging. The secondary battery 110 is, for example, a lithium ion battery or a lead-acid battery. The secondary battery 110 is charged by electric power supplied from the power grid 300 through an analog-to-digital (AC/DC) conversion device 121 in the adjustment device 120 and the DC/DC conversion device 130. In addition, the secondary battery 110 supplies electric power to the load apparatus 200 by discharging stored electric power through the DC/DC conversion device 130 and a DC/AC conversion device 122 in the adjustment device 120.

The DC/DC conversion device 130 is a converter that controls charging and discharging of the secondary battery 110 in accordance with an instruction from the charge-discharge instruction device 180. The converter may be used a constant-voltage converter or a constant-current converter. With respect to the DC/DC conversion device 130, a voltage on the secondary battery 110 side is also referred to as a first voltage, and a voltage on the DC/AC conversion device 122 side is also referred to as a second voltage. The uninterruptible power system 100 does not necessarily need to include the DC/DC conversion device 130.

The secondary-battery monitoring device 140 monitors a charging state (also referred to as state of charge (SoC)) of the secondary battery 110. The charging state is expressed by, for example, the ratio of a stored electric energy to a battery capacity, and is represented by a value equal to or greater than zero and equal to or less than one. The charging state may be represented as the value of the stored electric energy itself or may be represented in ranks. Thus, various kinds of indicators for indicating the charging state of the secondary battery 110 may be used. The secondary-battery monitoring device 140 inputs a monitoring result of the charging state of the secondary battery to the charge-discharge amount calculation device 170.

The voltage measurement device 150 is connected to a charge device of the power grid 300 and measures the voltage (also referred to as grid voltage) of the power grid 300. The voltage measurement device 150 includes a transformer (voltage transformer (VT)) 151 and an A/D converter 152. The transformer 151 steps down a high voltage of the grid to a predetermined voltage that is measurable by the voltage measurement device 150. Alternatively, an insulation transformer may be provided in the voltage measurement device 150 in order to prevent entry of noise from the power grid 300 or the like. The A/D converter 152 converts an analog voltage value stepped down by the transformer 151 into a digital value. The converted analog value is input to the frequency measurement device 160.

The frequency measurement device 160 measures the frequency (grid frequency) of the power grid 300 from measurement information of the voltage measurement device 150, and inputs the frequency to the charge-discharge amount calculation device 170 as a digital value. The frequency measurement device 160 measures the frequency at intervals of 20 msec, for example. The value of the frequency is averaged over a relatively short period and is calculated as a digital value. The uninterruptible power system 100 of the present embodiment employs, as this digital value, the frequency averaged over a relatively short period. The frequency is averaged over a period from a first time point as a reference to a second time point later than the first time point. The uninterruptible power system 100 can set a plurality of first time points within a relatively short period. Accordingly, two moving periods, namely, a first moving period and a second moving period that is longer than the first moving period can be set. The second time point is, for example, the latest time point at which the frequency is measured. For example, the start of the first moving period is later than the start of the second moving period, and the end of the first moving period and the end of the second moving period are the same.

For example, at least part of the first moving period and at least part of the second moving period overlap.

The charge-discharge amount calculation device 170 holds frequency values measured at a plurality of time points by the frequency measurement device 160. The charge-discharge amount calculation device 170 calculates a moving average value of the grid frequency in a predetermined period by using these values. The moving average value is obtained by, for example, a simple moving average or a weighted moving average. Specifically, the charge-discharge amount calculation device 170 calculates a first moving average value in the first moving period. The charge-discharge amount calculation device 170 also calculates a second moving average value in the second moving period. In addition, the charge-discharge amount calculation device 170 determines charge-discharge power based on a frequency deviation that is the difference between the reference frequency of the grid frequency and the calculated first or second moving average value.

The first moving average value represents the frequency in the recent short first moving period, and the second moving average value represents the frequency in the recent second moving period that is longer than the first moving period.

A charge-discharge amount can be adjusted in accordance with whether the charge-discharge power is determined based on the first moving average value or the second moving average value.

The simple moving average is calculated as, for example, an average value of n (n is an integer of one or more) frequency values acquired in a moving period. The weighted moving average is calculated by performing a moving average in which different weights pn are applied to n frequency values.

When the charging state of the secondary battery 110 monitored by the secondary-battery monitoring device 140 falls below a predetermined first threshold, the charge-discharge amount calculation device 170 calculates the first moving average value and the second moving average value of the grid frequency, and performs comparison therebetween. In this case, the charge-discharge amount calculation device 170 determines the charge-discharge power corresponding to the frequency deviation by using the larger one of the first moving average value and the second moving average value of the frequency.

When the charging state of the secondary battery 110 monitored by the secondary-battery monitoring device 140 exceeds a predetermined second threshold, the charge-discharge amount calculation device 170 compares the first moving average value and the second moving average value of the grid frequency. In this case, the charge-discharge amount calculation device 170 determines the charge-discharge power corresponding to the frequency deviation by using the smaller one of the first moving average value and the second moving average value of the frequency.

The first threshold is a value that serves as a lower reference for the discharging amount, and the second threshold is a value that is larger than the first threshold and serves as an upper reference of the charging amount. These values are design values and may be various values.

Information of a charge-discharge pattern in which the difference between a moving average value of the grid frequency and the reference frequency, in other words, the frequency deviation as the difference of the grid frequency from the reference frequency is associated with the charge-discharge power is stored in the uninterruptible power system 100 in advance. The charge-discharge amount calculation device 170 can selectively switch the charge-discharge power among a plurality of charge-discharge patterns in accordance with the first or second moving average value and the frequency deviation. In other words, one of a plurality of charge-discharge patterns in accordance with the SoC is selected.

For example, the charge-discharge amount calculation device 170 can switch between a first charge-discharge pattern and a second charge-discharge amount pattern. A selected charge-discharge pattern is also referred to as a use charge-discharge pattern.

In the present embodiment, the difference between the frequency moving average value and the reference frequency is calculated as “the frequency moving average value—the reference frequency”. However, this definition of the difference is exemplary, and the sign thereof may be reversed or the difference may be defined by a ratio of the two terms. The charge-discharge pattern information may be constituted by a database such as a look-up table, or may be a function that calculates an output variable in accordance with the value of an input variable. The function may be defined, for example, with the frequency deviation as an input variable and with a charge-discharge pattern as an output variable.

For example, in a case where the charge-discharge pattern information is constituted as a database, the information is stored in a non-illustrated storage in the uninterruptible power system 100 in advance. At startup of the uninterruptible power system 100, the charge-discharge amount calculation device 170 may load this database from the storage and use the database. In addition, similarly, in a case where a charge-discharge pattern is calculated by a function, the charge-discharge amount calculation device 170 may load the function from the storage and use the function.

The charge-discharge instruction device 180 controls at least one of the DC/DC conversion device 130 and the AC/DC conversion device 121 so that charging or discharging is performed by charging power or discharging power in accordance with a charge-discharge pattern determined by the charge-discharge amount calculation device 170. The charging power or discharging power thus set is also referred to as responsive reserve. The charge-discharge instruction device 180 inputs instruction information for performing charging or discharging by the charging power or discharging power determined by the charge-discharge amount calculation device 170 to at least one of the DC/DC conversion device 130 and the AC/DC conversion device 121. At least one of the DC/DC conversion device 130 and the AC/DC conversion device 121 controls the secondary battery 110 to perform charging or discharging by electric power in accordance with the instruction information.

The load apparatus 200 operates by electric power supplied from the power grid 300 and electric power supplied as the responsive reserve from the uninterruptible power system 100. For example, the load apparatus 200 is a server installed in a data center, a factory, or the like. Alternatively, the load apparatus 200 may be equipment such as a PC.

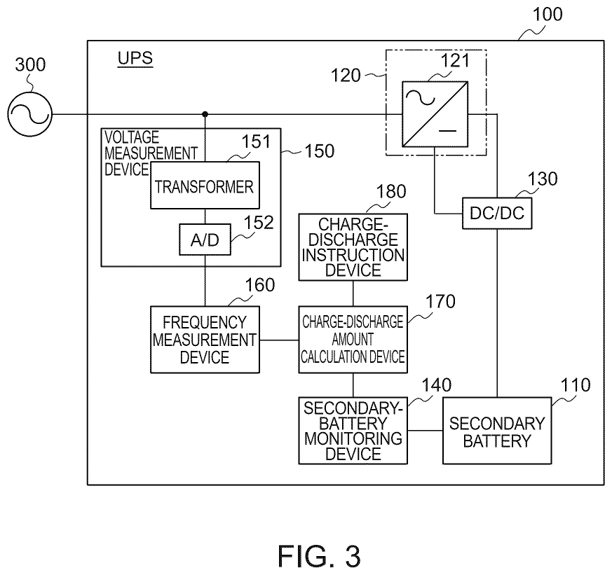

FIG. 3 is an example of another configuration diagram of the uninterruptible power system 100 in the first embodiment.

FIG. 3 illustrates a configuration example in a case where the uninterruptible power system 100 functions as a grid secondary-battery system. In the present embodiment, the uninterruptible power system 100 is described as a consumer equipment that supports operation of the load apparatus 200, but the uninterruptible power system 100 may be disposed as a power generation operator equipment that supports operation of the power grid 300, that is, a grid secondary-battery system.

In a case where the uninterruptible power system 100 functions as a grid secondary-battery system, charging from the power grid 300 to the secondary battery 110 or discharging from the secondary battery 110 to the power grid 300 is performed in accordance with the grid frequency.

In this example, the adjustment device 120 includes only the AC/DC conversion device 121, and performs conversion of electric power supplied from the power grid 300 to the secondary battery 110 or electric power supplied from the secondary battery 110 to the power grid 300. Control for supplying the responsive reserve and the other configurations are the same as in FIG. 1. The following description will be made on the configuration in FIG. 1.

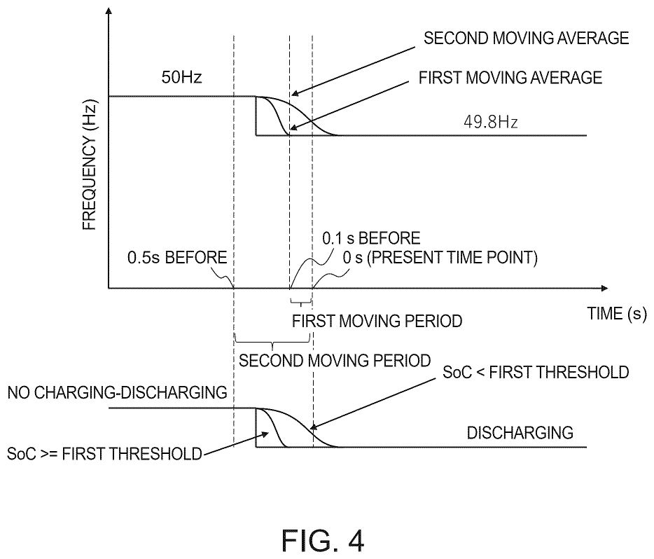

FIG. 4 is a diagram for description of an example of a method of determining a discharge pattern in the first embodiment.

Description with reference to FIG. 4 will be mainly made on an example in which, when the SoC value falls below the first threshold, the charge-discharge amount calculation device 170 calculates the first moving average value and the second moving average value, and determines a charge-discharge pattern based on the values. In addition, in the description, a first period is 0.1 seconds, and a second period is 0.5 seconds. Specifically, when the second time point in the first moving period is the present time point (time point of 0 seconds), the first time point is a time point 0.1 seconds before. In addition, when the second time point in the second moving period is the present time point, the first time point is a time point before 0.5 seconds.

As illustrated in the diagram, the grid frequency decreases from 50 Hz to 49.8 Hz, and discharging is needed to supply the responsive reserve from the secondary battery 110. On the other hand, the SoC value is smaller than the first threshold. In order to prevent the secondary battery 110 from being over-discharged and becoming unable to supply the responsive reserve, it is desirable to reduce the discharging amount in a transient period of the frequency. In such a case, the charge-discharge amount calculation device 170 calculates the first moving average value and the second moving average value of the frequency, and determines a discharge pattern corresponding to the second moving average value being the larger value.

The charge-discharge instruction device 180 controls at least one of the DC/DC conversion device 130 and the AC/DC conversion device 121 so that discharging is performed by discharging power in accordance with the discharge pattern determined by the charge-discharge amount calculation device 170.

On the other hand, when the SoC value does not fall below the first threshold, the remaining battery amount of the secondary battery 110 is sufficient and the battery is not over-discharged, and thus a discharge pattern corresponding to the first moving average value is determined.

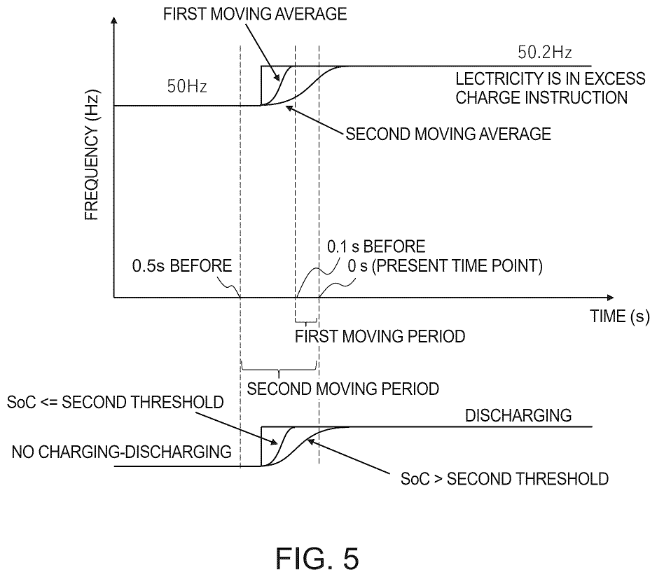

FIG. 5 is a diagram for description of an example of a method of determining a charge pattern in the first embodiment.

Description with reference to FIG. 5 will be mainly made on an example in which, when the SoC value exceeds the second threshold, the charge-discharge amount calculation device 170 calculates the first moving average value and the second moving average value, and determines a charge-discharge pattern based on the values. In addition, in the description, the first period is 0.1 seconds, and the second period is 0.5 seconds.

As illustrated in the diagram, the grid frequency increases from 50 Hz to 50.2 Hz, and charging is needed to supply the responsive reserve from the secondary battery 110. On the other hand, the SoC value is larger than the second threshold. In order to prevent the secondary battery 110 from being fully charged and becoming unable to supply the responsive reserve, it is desirable to reduce the charging amount in a transient period of the frequency. In such a case, the charge-discharge amount calculation device 170 calculates the first moving average value and the second moving average value of the grid frequency, and determines a charge pattern corresponding to the second moving average value being the smaller value.

The charge-discharge instruction device 180 controls at least one of the DC/DC conversion device 130 and the AC/DC conversion device 121 so that charging is performed by charging power in accordance with the charge pattern determined by the charge-discharge amount calculation device 170.

On the other hand, when the SoC value does not exceed the second threshold, the secondary battery 110 can be sufficiently charged and is not fully charged, and thus a charge pattern corresponding to the first moving average value is determined.

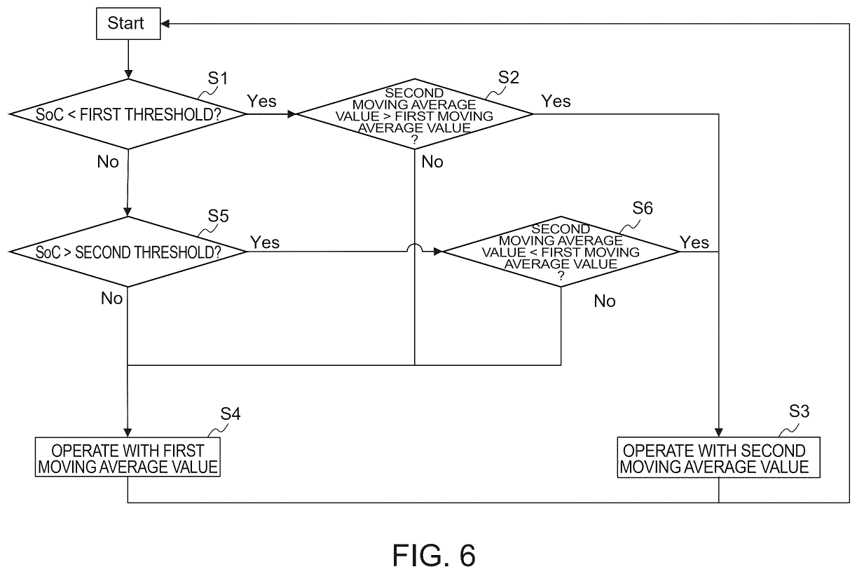

FIG. 6 is an example of a flowchart at a time of determining a charge-discharge pattern in the first embodiment.

Description with reference to the present flowchart will be mainly made on flows when the SoC value falls below the first threshold, when the SoC value exceeds the second threshold, and when the SoC value does not fall below the first threshold and the SoC value does not exceed the second threshold. In addition, in the description, the first threshold and the second threshold are stored in a non-illustrated storage and loaded at the start of the flowchart.

In step S1, the charge-discharge amount calculation device 170 compares the SoC value with the first threshold, and determines whether the SoC value falls below the first threshold and the remaining battery amount is decreasing. The charge-discharge amount calculation device 170 performs the determination by comparing the SoC value monitored by the secondary-battery monitoring device 140 with the first threshold.

In a case where it is determined that the SoC value is smaller than the first threshold (Yes in step S1), in step S2, the charge-discharge amount calculation device 170 calculates the first moving average value and the second moving average value of the grid frequency, and determines whether the second moving average value is larger than the first moving average value. The charge-discharge amount calculation device 170 calculates the first moving average value by performing a calculation such as a simple moving average on a plurality of frequency values in the first moving period. Similarly, the charge-discharge amount calculation device 170 also calculates the second moving average value by using a plurality of frequency values in the second moving period. Thereafter, the charge-discharge amount calculation device 170 performs comparison between these two moving average values. From a viewpoint of supplying the responsive reserve by the secondary battery 110, discharging is performed when the grid frequency is lower than the reference frequency, and charging is performed when the grid frequency is higher than the reference frequency. When the remaining battery amount of the secondary battery 110 is small, discharging is performed with low discharging power to avoid over-discharge, or charging is performed with high charging power. Thus, in subsequent step S3 or S4, charging or discharging of the secondary battery 110 is performed by using a charge-discharge pattern corresponding to the higher one of the first moving average value and the second moving average value.

In a case where it is determined that the second moving average value is larger than the first moving average value (Yes in step S2), in step S3, the charge-discharge amount calculation device 170 determines a charge-discharge pattern corresponding to the second moving average value. For example, the charge-discharge amount calculation device 170 determines a charge-discharge pattern corresponding to the second moving average value from a look-up table, and inputs this information to the charge-discharge instruction device 180. The charge-discharge instruction device 180 generates instruction information for controlling at least one of the DC/DC conversion device 130 and the AC/DC conversion device 121 so that charging or discharging of the secondary battery 110 is performed with charge-discharge power in accordance with the determined charge-discharge pattern. The charge-discharge instruction device 180 controls at least one of the DC/DC conversion device 130 and the AC/DC conversion device 121 by using the generated instruction information.

In a case where it is not determined that the second moving average value is larger than the first moving average value (No in step S2), in step S4, the charge-discharge amount calculation device 170 determines a charge-discharge pattern corresponding to the first moving average value. As in step S3, the charge-discharge instruction device 180 generates instruction information in accordance with charge-discharge pattern, and controls at least one of the DC/DC conversion device 130 and the AC/DC conversion device 121. After step S3 or S4, the process returns to step S1, and the SoC determination operation is repeated at a predetermined timing.

On the other hand, in a case where it is not determined that the SoC value is smaller than the first threshold (No in step S1), in step S5, the charge-discharge amount calculation device 170 compares the SoC value with the second threshold, and determines whether the SoC exceeds the second threshold and the remaining battery amount is in a state close to full charge. The charge-discharge amount calculation device 170 performs the determination by comparing the SoC value with the second threshold.

In a case where it is determined that the SoC value is larger than the first threshold (Yes in step S5), in step S6, the charge-discharge amount calculation device 170 calculates the first moving average value and the second moving average value of the grid frequency, and determines whether the first moving average value is larger than the second moving average value. The charge-discharge amount calculation device 170 calculates the first moving average value by performing a calculation such as a simple moving average on a plurality of frequency values in the first moving period. Similarly, the charge-discharge amount calculation device 170 also calculates the second moving average value by using a plurality of frequency values in the second moving period. Thereafter, the charge-discharge amount calculation device 170 performs comparison between these two moving average values. From a viewpoint of supplying the responsive reserve by the secondary battery 110, discharging is performed when the grid frequency is lower than the reference frequency, and charging is performed when the grid frequency is higher than the reference frequency. When the secondary battery 110 is in a state close to full charge, discharging is performed with high discharging power, or charging is performed with low charging power to avoid over-charge. Thus, in subsequent step S3 or S4, charging or discharging of the secondary battery 110 is performed by using a charge-discharge pattern corresponding to the lower one of the first moving average value and the second moving average value.

In a case where it is determined that the second moving average value is smaller than the first moving average value (Yes in step S6), in step S3, the charge-discharge amount calculation device 170 determines a charge-discharge pattern corresponding to the second moving average value. The charge-discharge instruction device 180 generates instruction information for controlling at least one of the DC/DC conversion device 130 and the AC/DC conversion device 121 so that charging or discharging of the secondary battery 110 is performed with charge-discharge power in accordance with the determined charge-discharge pattern. The charge-discharge instruction device 180 controls at least one of the DC/DC conversion device 130 and the AC/DC conversion device 121 by using the generated instruction information.

In a case where it is not determined that the second moving average value is smaller than the first moving average value (No in step S6), in step S4, the charge-discharge amount calculation device 170 determines a charge-discharge pattern corresponding to the first moving average value. As in step S3, the charge-discharge instruction device 180 generates instruction information in accordance with the charge-discharge pattern, and controls at least one of the DC/DC conversion device 130 and the AC/DC conversion device 121. After step S3 or S4, the process returns to step S1, and the SoC determination operation is repeated at a predetermined timing.

On the other hand, in a case where it is not determined that the SoC value is larger than the first threshold (No in step S5), the process proceeds to step S4, and as in the above description, the charge-discharge instruction device 180 generates instruction information based on the charge-discharge pattern corresponding to the first moving average value and determined by the charge-discharge amount calculation device 170, and controls at least one of the DC/DC conversion device 130 and the AC/DC conversion device 121. Similarly, after this step, the process returns to step S1 again, and the SoC determination operation is repeated at a predetermined timing.

According to the present embodiment, in a case where the SoC value is smaller than the first threshold, the uninterruptible power system 100 determines the charge-discharge power of the secondary battery 110 based on the result of a comparison between the first moving average value and the second moving average value. Specifically, the uninterruptible power system 100 performs charging or discharging of the secondary battery 110 by using a charge-discharge pattern corresponding to the larger one of the first moving average value and the second moving average value. Accordingly, the uninterruptible power system 100 can adjust the charge-discharge amount of the secondary battery in accordance with a variation in the grid frequency to prevent the secondary battery from becoming over-discharged at an early stage.

Moreover, according to the present embodiment, in a case where the SoC value is larger than the second threshold, the uninterruptible power system 100 determines the charge-discharge amount of the secondary battery 110 based on the result of comparison between the first moving average value and the second moving average value. Specifically, the uninterruptible power system 100 performs charging of the secondary battery 110 by using a charge-discharge pattern corresponding to the smaller one of the first moving average value and the second moving average value. Accordingly, the uninterruptible power system 100 can adjust the charge-discharge amount of the secondary battery in accordance with a variation in the grid frequency to prevent the secondary battery from becoming fully charged at an early stage.

Moreover, according to the present embodiment, the uninterruptible power system 100 can be used not only as a power source for the load apparatus 200 during a power outage, but also as a supply source of the responsive reserve for adjusting the charge-discharge amount in response to a variation in the grid frequency.

### Second Embodiment

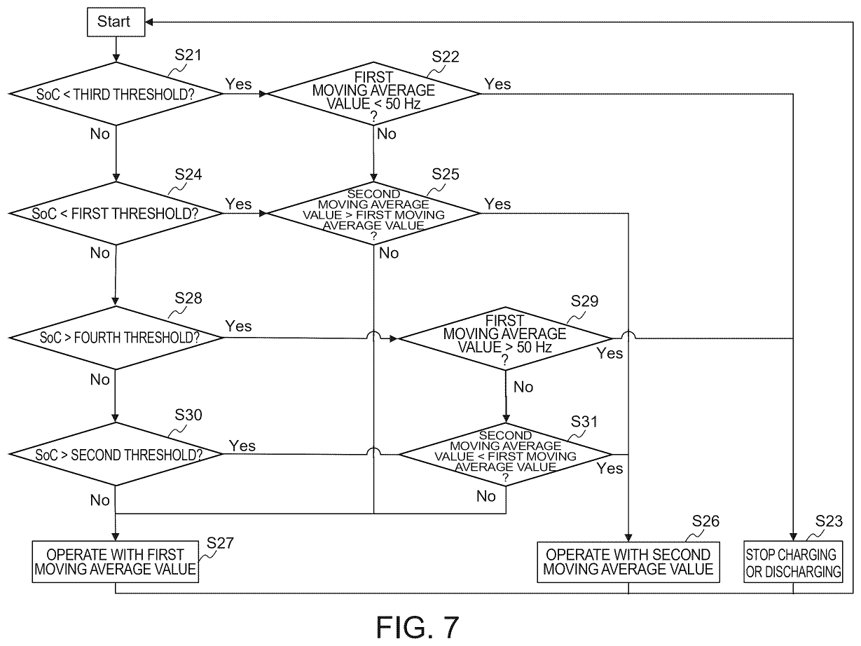

FIG. 7 is an example of a flowchart at a time of determining a charge-discharge pattern and the like in a second embodiment.

In the present embodiment, the uninterruptible power system 100 is provided with a protection function for the secondary battery 110, in comparison with the first embodiment. When the SoC value of the secondary battery 110 is smaller than a third threshold that is smaller than the first threshold, discharging is close to over-discharge. Thus, discharging is stopped under predetermined conditions based on calculation by the charge-discharge amount calculation device 170. In addition, when the SoC value of the secondary battery 110 is larger than a fourth threshold that is larger than the second threshold, charging is close to over-charge. Thus, charging is stopped under predetermined conditions based on calculation by the charge-discharge amount calculation device 170. Parts similar to those in the first embodiment, such as a schematic configuration diagram of the power grid 1 in the present embodiment, will be omitted from description.

In step S21, the charge-discharge amount calculation device 170 compares the SoC value with the third threshold, and determines whether the SoC value falls below the first threshold and the remaining battery amount is decreasing. The charge-discharge amount calculation device 170 performs the determination by comparing the SoC value monitored by the secondary-battery monitoring device 140 with the first threshold.

In a case where it is determined that the SoC value is smaller than the third threshold (Yes in step S21), in step S22, the charge-discharge amount calculation device 170 calculates the first moving average value of the grid frequency, and determines whether the first moving average value is smaller than 50 Hz, which is the reference frequency. The charge-discharge amount calculation device 170 calculates the first moving average value by performing a calculation such as a simple moving average on a plurality of frequency values in the first moving period. Thereafter, the charge-discharge amount calculation device 170 performs comparison between the first moving average value and the reference frequency. Similarly, the charge-discharge amount calculation device 170 may calculate the second moving average value of the grid frequency, and may determine whether the second moving average value is smaller than the reference frequency.

In a case where it is determined that the first moving average value is smaller than the reference frequency (Yes in step S22), in step S23, the charge-discharge amount calculation device 170 stops discharging of the secondary battery 110 to protect the secondary battery 110 from over-discharge. Instead, in a case where it is determined that both the first moving average value and the second moving average value are smaller than the reference frequency, the charge-discharge amount calculation device 170 may stop charging of the secondary battery 110. After this step, the process returns to step S21, and the SoC value determination operation may be repeated at a predetermined timing, or the uninterruptible power system 100 may be stopped until reactivation of a power source is performed by a user.

In a case where it is not determined that the first moving average value is smaller than the reference frequency (No in step S22), in step S25, the charge-discharge amount calculation device 170 calculates the first moving average value and the second moving average value of the grid frequency, and determines whether the second moving average value is larger than the first moving average value. The flow of this step is the same as that of step S2 described above.

In a case where it is determined that the second moving average value is larger than the first moving average value (Yes in step S25), in step S26, the charge-discharge amount calculation device 170 determines a charge-discharge pattern corresponding to the second moving average value. The charge-discharge instruction device 180 generates instruction information for controlling at least one of the DC/DC conversion device 130 and the AC/DC conversion device 121 so that charging or discharging of the secondary battery 110 is performed with charge-discharge power in accordance with the determined charge-discharge pattern, and controls at least one of the DC/DC conversion device 130 and the AC/DC conversion device 121. The flow of this step is the same as that of step S3 described above.

In a case where it is not determined that the second moving average value is larger than the first moving average value (No in step S25), in step S27, the charge-discharge amount calculation device 170 determines a charge-discharge pattern corresponding to the first moving average value. As in step S3, the charge-discharge instruction device 180 generates instruction information in accordance with the charge-discharge pattern, and controls at least one of the DC/DC conversion device 130 and the AC/DC conversion device 121. The flow of this step is the same as that of step S4 described above. After step S26 or S27, the process returns to step S21, and the SoC value determination operation is repeated at a predetermined timing.

In a case where it is not determined that the SoC value is smaller than the third threshold (No in step S21), in step S24, the charge-discharge amount calculation device 170 compares the SoC value with the first threshold, and determines whether the SoC value falls below the first threshold and the remaining battery amount is decreasing. The charge-discharge amount calculation device 170 performs the determination by comparing the SoC value with the first threshold. The flow of this step is the same as that of step S1 described above.

In a case where it is determined that the SoC value is smaller than the first threshold (Yes in step S24), the operation in step S25 is performed. After step S25, charging-discharging operation of the uninterruptible power system 100 is performed in accordance with the above-described flow.

In a case where it is not determined that the SoC value is smaller than the first threshold (No in step S24), in step S28, the charge-discharge amount calculation device 170 compares the SoC value with the fourth threshold, and determines whether the SoC value exceeds the fourth threshold and the remaining battery amount is in a state close to full charge. The charge-discharge amount calculation device 170 performs the determination by comparing the SoC value monitored by the secondary-battery monitoring device 140 with the fourth threshold.

In a case where it is determined that the SoC value is larger than the fourth threshold (Yes in step S28), in step S29, the charge-discharge amount calculation device 170 calculates the first moving average value of the grid frequency, and determines whether the first moving average value is larger than 50 Hz, which is the reference frequency. The charge-discharge amount calculation device 170 calculates the first moving average value by performing a calculation such as a simple moving average on a plurality of frequency values in the first moving period. Thereafter, the charge-discharge amount calculation device 170 performs comparison between the first moving average value and the reference frequency. Similarly, the charge-discharge amount calculation device 170 may calculate the second moving average value of the grid frequency, and may determine whether the second moving average value is larger than the reference frequency.

In a case where it is determined that the first moving average value is larger than the reference frequency (Yes in step S29), in step S23, the charge-discharge amount calculation device 170 stops charging of the secondary battery 110 to protect the secondary battery 110 from over-charge. Instead, in a case where it is determined that both the first moving average value and the second moving average value are larger than the reference frequency, the charge-discharge amount calculation device 170 may stop charging of the secondary battery 110. After this step, the process returns to step S21, and the SoC value determination operation may be repeated at a predetermined timing, or the uninterruptible power system 100 may be stopped until reactivation of a power source is performed by a user.

In a case where it is not determined that the first moving average value is larger than the reference frequency (No in step S29), in step S31, the charge-discharge amount calculation device 170 calculates the first moving average value and the second moving average value of the grid frequency, and determines whether the first moving average value is larger than the second moving average value. The flow of this step is the same as that of step S6 described above.

In a case where it is determined that the second moving average value is smaller than the first moving average value (Yes in step S31), the process proceeds to step S26. In a case where it is not determined that the second moving average value is smaller than the first moving average value (No in step S6), the process proceeds to step S27. After step S26 or S27, the process returns to step S21, and the SoC value determination operation is repeated at a predetermined timing.

In a case where it is not determined that the SoC value is larger than the fourth threshold (No in step S28), the process proceeds to step S27, and as in the above description, the charge-discharge instruction device 180 generates instruction information based on the charge-discharge pattern corresponding to the first moving average value and determined by the charge-discharge amount calculation device 170, and controls at least one of the DC/DC conversion device 130 and the AC/DC conversion device 121. Similarly, after this step, the process returns to step S1, and the SoC determination operation is repeated at a predetermined timing.

According to the present embodiment, in a case where the SoC value of the secondary battery 110 is smaller than the third threshold and the secondary battery 110 is close to over-discharge, the uninterruptible power system 100 is stopped when the first moving average value of the grid frequency falls below the reference frequency. Accordingly, the uninterruptible power system 100 can protect the secondary battery 110, thereby preventing the secondary battery 110 from being over-discharged.

Moreover, according to the present embodiment, in a case where the SoC value of the secondary battery 110 is larger than the fourth threshold and the secondary battery 110 is close to over-charge, the uninterruptible power system 100 is stopped when the first moving average value of the grid frequency exceeds the reference frequency. Accordingly, the uninterruptible power system 100 can protect the secondary battery 110, thereby preventing the secondary battery 110 from being over-charged.

### Third Embodiment

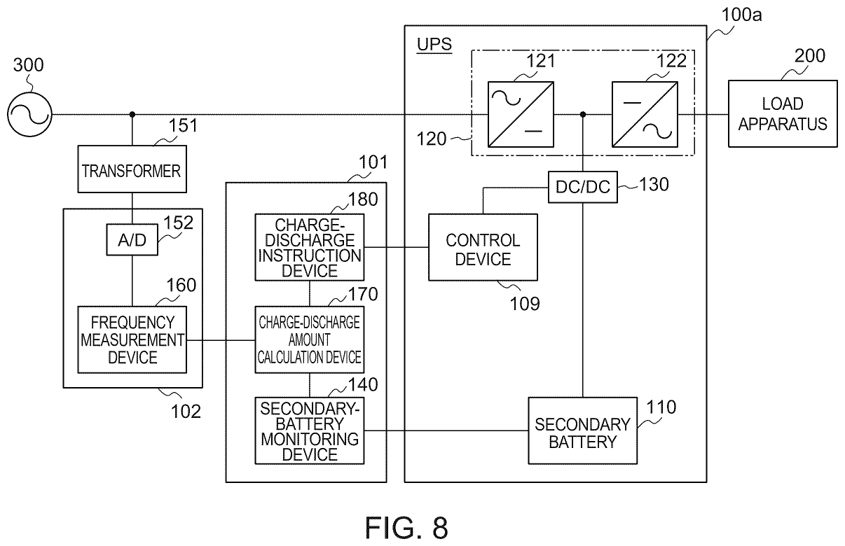

FIG. 8 is a schematic configuration diagram of the power grid 1 in a third embodiment.

In the configuration of the present embodiment, a power supply control system 101 and a frequency measurement apparatus 102 are externally connected to the existing uninterruptible power system 100, and the responsive reserve is supplied in accordance with a variation in the grid frequency. Moreover, in the present embodiment, the existing uninterruptible power system 100 is referred to as an uninterruptible power system 100a to distinguish the existing uninterruptible power system 100 from the uninterruptible power system 100 described above in the first and second embodiments. The uninterruptible power system 100 described above in the first and second embodiments may be a system including the power supply control system 101 inside. In the present embodiment, description will be mainly made on differences from the first and second embodiments.

The uninterruptible power system 100a includes the secondary battery 110, the adjustment device 120, the DC/DC conversion device 130, and a control device 190. The power supply control system 101 includes the secondary-battery monitoring device 140, the charge-discharge amount calculation device 170, and the charge-discharge instruction device 180. In addition, the frequency measurement apparatus 102 includes the A/D converter 152 and the frequency measurement device 160.

The control device 190 can control the entire operation of the uninterruptible power system 100a, and can also receive an input from the power supply control system 101 and control the uninterruptible power system 100a. In the example illustrated in FIG. 8, the control device 190 receives an input of instruction information from the charge-discharge instruction device 180, and inputs the instruction information to at least one of the DC/DC conversion device 130 and the AC/DC conversion device 121. At least one of the DC/DC conversion device 130 and the AC/DC conversion device 121 controls the secondary battery 110 to perform charging or discharging with electric power in accordance with the instruction information.

The power supply control system 101 can be implemented by, for example, installing a computer program for the power supply control system 101 on a personal computer (PC). As a central processing unit (CPU) in the power supply control system 101 executes the computer program for the power supply control system 101, the functions of the charge-discharge instruction device 180, the charge-discharge amount calculation device 170, and the secondary-battery monitoring device 140 are implemented.

In the power supply control system 101 in the present embodiment, operations of respective functional blocks are the same as in the above-described embodiments. Specifically, the charge-discharge amount calculation device 170 holds frequency values at a plurality of time points when inputs from the frequency measurement device 160 included in the frequency measurement apparatus 102 are received, and determines a charge-discharge pattern based on these values. The charge-discharge instruction device 180 generates instruction information in accordance with the charge-discharge pattern, and inputs the instruction information to the control device 190 included in the uninterruptible power system 100a. The control device 190 controls at least one of the DC/DC conversion device 130 and the AC/DC conversion device 121 based on the instruction information.

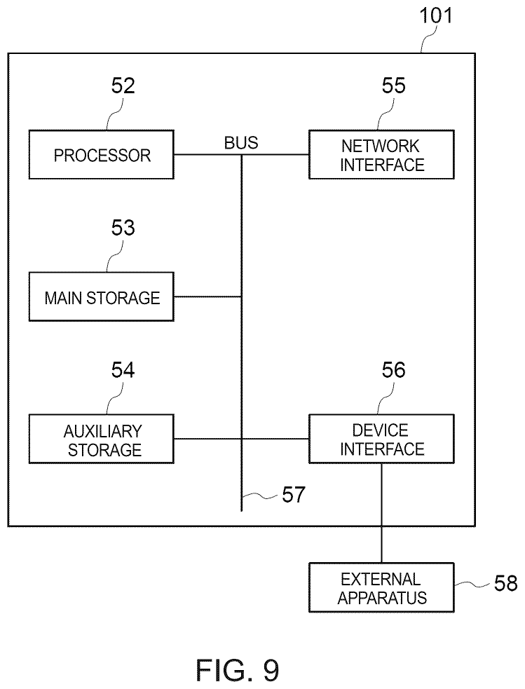

FIG. 9 is a hardware configuration diagram of the power supply control system 101 in the third embodiment.

The power supply control system 101 in FIG. 9 includes a processor 52 such as a CPU, a main storage 53 such as a RAM, an auxiliary storage 54 such as a HDD, a network interface 55 such as a local area network (LAN) board, a device interface 56 such as a memory slot or a memory port, and a bus 57 connecting these instruments. The power supply control system 101 is, for example, a computer such as a PC, and includes an external input apparatus such as a keyboard or a mouse, and a display apparatus such as an LCD monitor.

In the present embodiment, a computer program for causing a computer to execute information processing of the power supply control system 101 is installed in the auxiliary storage 54. The power supply control system 101 loads the computer program onto the main storage 53, and executes the computer program by the processor 52. Accordingly, the functions of the secondary-battery monitoring device 140, the charge-discharge amount calculation device 170, and the charge-discharge instruction device 180 illustrated in FIG. 8 are implemented in the power supply control system 101 to enable control of the uninterruptible power system 100 for supply of the responsive reserve, which is described above in the third embodiment. Note that the calculation result of this information processing is temporarily held in the main storage 53, or is stored and saved in the auxiliary storage 54. The above-described storage is configured on the auxiliary storage 54.

The charge-discharge pattern information is stored in the auxiliary storage 54 in addition to the above-described thresholds and the values of the first moving period and the second moving period. Each data is loaded onto the main storage 53 during execution of the computer program.

The power supply control system 101 is connected to the frequency measurement apparatus 102 through the network interface 55. The power supply control system 101 acquires a frequency digital value from the frequency measurement device 160 through the network interface 55.

The computer program for the power supply control system 101 can be installed by, for example, attaching an external apparatus 58 in which the computer program is recorded to the device interface 56, and storing the computer program from the external apparatus 58 into the auxiliary storage 54. Examples of the external apparatus 58 are a computer-readable recording medium and a recording apparatus incorporating such a recording medium. Examples of the recording medium are a compact disk read only memory (CD-ROM), a compact disk recordable (CD-R), a flexible disk, a digital versatile disk read only memory (DVD-ROM), and a digital versatile disk recordable (DVD-R), and an example of the recording apparatus is a HDD. The computer program can be installed by, for example, downloading the computer program through the network interface 55.

According to the present embodiment, the power grid 1 includes the power supply control system 101 externally connected to the uninterruptible power system 100a. By providing instruction information from the external power supply control system 101 to the uninterruptible power system 100a, the technology described above in the above-described embodiments can also be applied to the existing uninterruptible power system 100a. In other words, the uninterruptible power system 100a can be utilized as a resource of the responsive reserve for adjusting the charge-discharge amount in response to a variation in the grid frequency.

### Fourth Embodiment

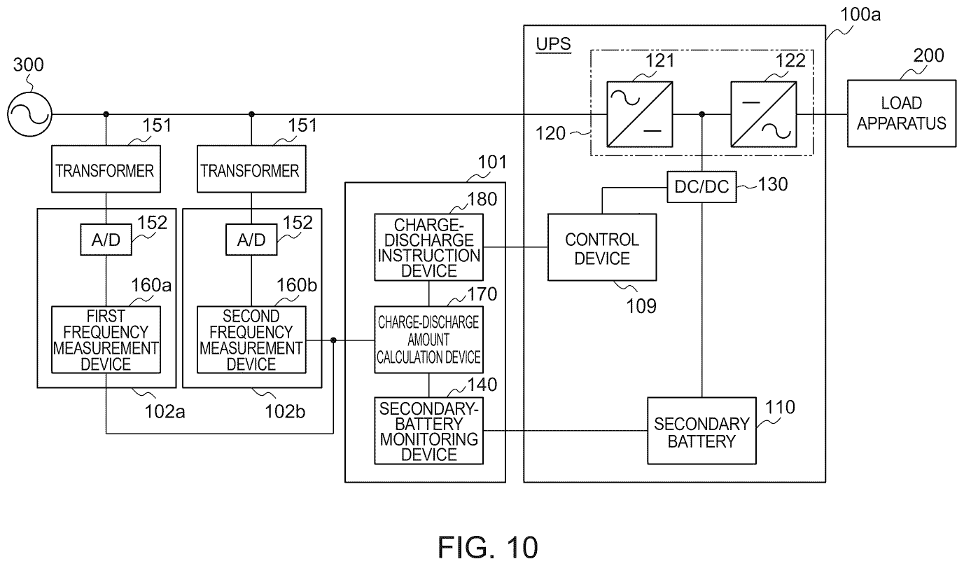

FIG. 10 is a schematic configuration diagram of the power grid 1 in a fourth embodiment.

The charge-discharge amount calculation device 170 may use, as each moving average value, the result of a averaging filter, a smoothing filter, or output calculation of a first-order lag system having a different time constant (delay time). Alternatively, the charge-discharge amount calculation device 170 may use, as the moving average values, outputs of two low-pass filters (LPFs) having different cutoff frequencies. In the present embodiment, description will be mainly made on differences from the first to third embodiments.

In the present embodiment, the configuration of the frequency measurement apparatus 102 is different in comparison with the third embodiment. In the example illustrated in FIG. 7, the power grid 1 includes a first frequency measurement apparatus 102a and a second frequency measurement apparatus 102b that perform output calculation of transfer functions of different first-order lag systems, respectively. The first frequency measurement apparatus 102a includes a first frequency measurement device 160a and the A/D converter 152. The second frequency measurement apparatus 102b includes a second frequency measurement device 160b and the A/D converter 152.

The first frequency measurement device 160a has a predetermined first delay time, and the second frequency measurement device 160b has a predetermined second delay time that is different from the first delay time. The charge-discharge amount calculation device 170 uses, as the first moving average value, a frequency acquired from the first frequency measurement device 160a. In addition, the charge-discharge amount calculation device 170 uses, as the second moving average value, a frequency acquired from the second frequency measurement device 160b.

According to the present embodiment, the power grid 1 includes the first frequency measurement device 160a and the second frequency measurement device 160b that perform output calculation of transfer functions of different first-order lag systems, respectively. Accordingly, the first moving average value and the second moving average value can be easily calculated.

The several embodiments have been described above, but these embodiments are merely examples, and do not intend to limit the scope of the invention. The novel uninterruptible power system 100 described in this specification can be implemented in various other forms. The forms of the uninterruptible power system 100 described in the present specification can be variously omitted, replaced, or modified without departing from the gist of the invention. The attached CLAIMS and equivalents thereof intend to encompass such forms or modifications included in the scope and the gist of the invention.

### Notes

The present embodiments and their modifications may be configured as described below, for example.
(1)

An uninterruptible power system that receives supply of electric power from a power grid to perform charging or supplies electric power to the power grid by performing discharging, the uninterruptible power system comprising:
a secondary battery that is capable of charging and discharging;
a frequency measurement device that measures frequencies at a plurality of time points in the power grid; and
a charge-discharge amount calculation device that determines a charge-discharge pattern indicating charging power or discharging power of the secondary battery based on an SoC of the secondary battery and the frequencies at the plurality of time points.
(2)

The uninterruptible power system according to (1), wherein the charge-discharge amount calculation device
calculates a first moving average value in a first moving period and a second moving average value in a second moving period that is longer than the first moving period among the frequencies at the plurality of time points, and
determines the charge-discharge pattern based on a comparison between the first moving average value and the second moving average value.
(3)

The uninterruptible power system according to (2), wherein the charge-discharge amount calculation device performs charging or discharging in the charge-discharge amount corresponding to a larger one of the first moving average value and the second moving average value, when an SoC value is equal to or smaller than a first threshold.
(4)

The uninterruptible power system according to (2) or (3), wherein the charge-discharge amount calculation device performs charging or discharging in the charge-discharge amount corresponding to a smaller one of the first moving average value and the second moving average value, when an SoC value is equal to or larger than a second threshold.
(5)

The uninterruptible power system according to any one of (2) to (4), wherein the charge-discharge amount calculation device stops discharging when an SoC value is equal to or smaller than a third threshold that is smaller than a first threshold, and when both the first moving average value and the second moving average value are smaller than a reference frequency of the power grid.
(6)

The uninterruptible power system according to any one of (2) to (5), wherein the charge-discharge amount calculation device stops charging when an SoC value is equal to or larger than a fourth threshold that is larger than a second threshold, and when both the first moving average value and the second moving average value are larger than a reference frequency of the power grid.
(7)

The uninterruptible power system according to any one of (2) to (6), wherein at least part of the first moving period and at least part of the second moving period overlap.
(8)

The uninterruptible power system according to (7), wherein an end time point of the first moving period and an end time point of the second moving period are the same.
(9)

A power supply control system that controls an uninterruptible power system that receives supply of electric power from a power grid to perform charging or supplies electric power to the power grid by performing discharging, the power supply control system comprising a charge-discharge amount calculation device that
receives an input of frequencies at a plurality of time points in the power grid, and
determines a charge-discharge pattern indicating charging power or discharging power of a secondary battery included in the uninterruptible power system based on an SoC of the secondary battery and the frequencies at the plurality of time points.
(10)

The power supply control system according to (9), wherein the charge-discharge amount calculation device
calculates a first moving average value in a first moving period and a second moving average value in a second moving period that is longer than the first moving period among the frequencies at the plurality of time points, and
determines the charge-discharge pattern based on a comparison between the first moving average value and the second moving average value.
(11)

The power supply control system according to (10), wherein the charge-discharge amount calculation device performs charging or discharging in the charge-discharge amount corresponding to a larger one of the first moving average value and the second moving average value, when an SoC value is equal to or smaller than a first threshold.
(12)

The power supply control system according to (10) or (11), wherein the charge-discharge amount calculation device performs charging or discharging in the charge-discharge amount corresponding to a smaller one of the first moving average value and the second moving average value, when an SoC value is equal to or larger than a second threshold.
(13)

The power supply control system according to any one of (10) to (12), wherein the charge-discharge amount calculation device stops discharging when an SoC value is equal to or smaller than a third threshold that is smaller than a first threshold, and when both the first moving average value and the second moving average value are smaller than a reference frequency of the power grid.
(14)

The power supply control system according to any one of (10) to (13), wherein the charge-discharge amount calculation device stops charging when an SoC value is equal to or larger than a fourth threshold that is larger than a second threshold, and when both the first moving average value and the second moving average value are larger than a reference frequency of the power grid.
(15)

The power supply control system according to any one of (10) to (14), wherein at least part of the first moving period and at least part of the second moving period overlap.
(16)

The power supply control system according to (15), wherein an end time point of the first moving period and an end time point of the second moving period are the same.
(17)

The power supply control system according to (9), wherein the charge-discharge amount calculation device
receives, as an input, a first moving average value in a first moving period, the first moving average value being calculated by a first frequency measurement device that performs output calculation of a transfer function of a first-order lag system,
receives, as an input, a second moving average value in a second moving period that is longer than the first moving period, the second moving average value being calculated by a second frequency measurement device that is different from the first frequency measurement device and performs output calculation of a transfer function of a first-order lag system, and
determines the charge-discharge pattern based on a comparison between the first moving average value and the second moving average value.

1. An uninterruptible power system that receives supply of electric power from a power grid to perform charging or supplies electric power to the power grid by performing discharging, the uninterruptible power system comprising:
a secondary battery that is capable of charging and discharging;
a frequency measurement device that measures frequencies at a plurality of time points in the power grid; and
a charge-discharge amount calculation device that determines a charge-discharge pattern indicating charging power or discharging power of the secondary battery based on a state of charge (SoC) of the secondary battery and the frequencies at the plurality of time points.

2. The system of claim 1, wherein the charge-discharge amount calculation device
calculates a first moving average value in a first moving period and a second moving average value in a second moving period that is longer than the first moving period among the frequencies at the plurality of time points, and
determines the charge-discharge pattern based on a comparison between the first moving average value and the second moving average value.

3. The system of claim 2, wherein the charge-discharge amount calculation device performs charging or discharging in a charge-discharge amount corresponding to a larger one of the first moving average value and the second moving average value, when an SoC value is equal to or smaller than a first threshold.

4. The system of claim 2, wherein the charge-discharge amount calculation device performs charging or discharging in a charge-discharge amount corresponding to a smaller one of the first moving average value and the second moving average value, when an SoC value is equal to or larger than a second threshold.

5. The system of claim 2, wherein the charge-discharge amount calculation device stops discharging when an SoC value is equal to or smaller than a third threshold that is smaller than a first threshold, and when both the first moving average value and the second moving average value are smaller than a reference frequency of the power grid.

6. The system of claim 2, wherein the charge-discharge amount calculation device stops charging when an SoC value is equal to or larger than a fourth threshold that is larger than a second threshold, and when both the first moving average value and second moving average value are larger than a reference frequency of the power grid.

7. The system of claim 2, wherein at least part of the first moving period and at least part of the second moving period overlap.

8. The system of claim 7, wherein an end time point of the first moving period and an end time point of the second moving period are the same.

9. A power supply control system that controls an uninterruptible power system that receives supply of electric power from a power grid to perform charging or supplies electric power to the power grid by performing discharging, the power supply control system comprising a charge-discharge amount calculation device that
receives an input of frequencies at a plurality of time points in the power grid, and
determines a charge-discharge pattern indicating charging power or discharging power of a secondary battery included in the uninterruptible power system based on an SoC of the secondary battery and the frequencies at the plurality of time points.

10. The system of claim 9, wherein the charge-discharge amount calculation device
calculates a first moving average value in a first moving period and a second moving average value in a second moving period that is longer than the first moving period among the frequencies at the plurality of time points, and
determines the charge-discharge pattern based on a comparison between the first moving average value and the second moving average value.

11. The system of claim 10, wherein the charge-discharge amount calculation device performs charging or discharging in a charge-discharge amount corresponding to a larger one of the first moving average value and the second moving average value, when an SoC value is equal to or smaller than a first threshold.

12. The system of claim 10, wherein the charge-discharge amount calculation device performs charging or discharging in a charge-discharge amount corresponding to a smaller one of the first moving average value and the second moving average value, when an SoC value is equal to or larger than a second threshold.

13. The system of claim 10, wherein the charge-discharge amount calculation device stops discharging when an SoC value is equal to or smaller than a third threshold that is smaller than a first threshold, and when both the first moving average value and the second moving average value are smaller than a reference frequency of the power grid.

14. The system of claim 10, wherein the charge-discharge amount calculation device stops charging when an SoC value is equal to or larger than a fourth threshold that is larger than a second threshold, and when both the first moving average value and the second moving average value are larger than a reference frequency of the power grid.

15. The system of claim 10, wherein at least part of the first moving period and at least part of the second moving period overlap.

16. The system of claim 15, wherein an end time point of the first moving period and an end time point of the second moving period are the same.

17. The system of claim 9, wherein the charge-discharge amount calculation device
receives, as an input, a first moving average value in a first moving period, the first moving average value being calculated by a first frequency measurement device that performs output calculation of a transfer function of a first-order lag system,
receives, as an input, a second moving average value in a second moving period that is longer than the first moving period, the second moving average value being calculated by a second frequency measurement device that is different from the first frequency measurement device and performs output calculation of a transfer function of a first-order lag system, and
determines the charge-discharge pattern based on a comparison between the first moving average value and the second moving average value.
